(19) United States
(12) Patent Application Publication
(10) Pub. No.: US 2025/0298980 A1
(43) Pub. Date: Sep. 25, 2025

(54) SYSTEMS AND METHODS FOR IMPROVED HANDLING OF OUT-OF-VOCABULARY WORDS IN SPEECH RECOGNITION SYSTEMS

(71) Applicant: Sprinklr, Inc., New York, NY (US)

(72) Inventors: Pavitar SINGH, Gurugram (IN); Yogin PATEL, Gandhinagar (IN); Aayush KUBBA, Gurgaon (IN); Yash JOGI, Ahmedabad (IN)

(21) Appl. No.: 19/083,244

(22) Filed: Mar. 18, 2025

Related U.S. Application Data
(60) Provisional application No. 63/567,166, filed on Mar. 19, 2024.

(51) Int. Cl. G06F 40/284; G10L 15/08; G10L 15/16

(52) U.S. Cl. CPC G06F 40/284; G10L 15/16; G10L 2015/081

(57) ABSTRACT

Systems and methods applicable, for instance, to improved handling of out-of-vocabulary words in speech recognition systems. A machine learning model can be trained to selectively associate frequency tokens with transcribed words. Once the model has been trained, a system can make a decision to turn on or turn off the use of contextual information for a given transcribed word, based on the frequency token placement decision made by the machine learning model for that transcribed word.

### CROSS-REFERENCE TO RELATED APPLICATIONS

This application claims priority to U.S. Provisional Patent Application Ser. No. 63/567,166, filed on Mar. 19, 2024, the contents of which are incorporated herein by reference in their entirety and for all purposes.

### FIELD OF THE INVENTION

The present technology relates to the field of speech recognition, and more specifically, but not exclusively, to techniques for improved handling of out-of-vocabulary words in speech recognition systems.

### BACKGROUND OF THE INVENTION

Automatic speech recognition (ASR) machine learning models (MLMs) can suffer from out of vocabulary (OOV) issues wherein the MLMs can perform poorly on words that are not present in (or rare within) their training data. Unfortunately, as just an example, many of the named entities that are crucial for a given client's use case—such as product names or company names—can fall into this category.

According to conventional approaches, ASR MLMs can be taught such OOV words by utilizing extensive audio data and fine tuning the ASR MLMs with it. However, such conventional approaches can suffer from many inadequacies, including but not limited to requiring significant resources in terms of time and/or money.

In view of at least the foregoing, a need exists for improved systems and methods for handling OOV words in speech recognition systems, in an effort to overcome the aforementioned obstacles and deficiencies of conventional approaches.

### BRIEF DESCRIPTION OF THE DRAWINGS

FIG. 1 is a diagram depicting an example difference between conventional ASR and frequency-aware ASR, according to various embodiments.

FIG. 2 is a diagram depicting an example of transforming training data used for conventional ASR into training data used for frequency-aware ASR, according to various embodiments.

FIG. 3 is a diagram depicting example frequency token placement and contextual information use, according to various embodiments.

FIG. 4 is a diagram depicting an example difference between conventional contextual information use and frequency-aware ASR contextual information use, according to various embodiments.

FIG. 5 is an example chart comparing conventional ASR and frequency-aware ASR, according to various embodiments.

FIG. 6 is an example chart depicting frequency token placement, according to various embodiments.

FIG. 7A is a diagram depicting an example encoder portion of a transformer encoder-decoder ASR, according to various embodiments.

FIG. 7B is a diagram depicting an example decoder portion of a transformer encoder-decoder ASR, according to various embodiments.

FIG. 8 is an example plot depicting PER_{OOD}, according to various embodiments.

FIG. 9 shows an example computer, according to various embodiments.

### DETAILED DESCRIPTION

According to various embodiments, the functionality discussed herein can allow ASR to improve the speech recognition accuracy for out-of-vocabulary words or words which are rare in the training word vocabulary of the ASR MLM. It is noted that an MLM, as discussed herein, can include a single MLM or multiple MLMs.

In one aspect, various of the functionality discussed herein allow an ASR MLM to detect whether a spoken word received by the ASR MLM is one that it has frequently encountered in the training word vocabulary of the ASR MLM. In another aspect, the ASR MLM can be capable of making use of context to help it improve the accuracy for out-of-vocabulary words or words which are rare in the training vocabulary of the ASR MLM, and various of the functionality discussed herein allow the ASR MLM to limit its use of such capability to circumstances where the MLM is uncertain about the transcript of the spoken word (e.g., as evidenced by it having detected that it has not frequently encountered the word in the training word vocabulary of the ASR MLM).

Accordingly, the ASR MLM can learn, in an end-to-end way, to predict whether a transcribed word was frequently present in the training dataset or not, along with learning the spelling of the word. Since such a model has knowledge of both the spelling of a particular word and its occurrence in the training dataset, such an ASR MLM can be referred to as a frequency-aware ASR MLM.

The ASR MLM can, as one example, include the capability of receiving audio data as input, and of generating as output spellings (e.g., phonetic spellings) of words spoken in the audio data, where the generated output further includes frequency tokens placed in front of words that the ASR MLM has frequently encountered the word in the past. Such a capability can, as just some examples, be implemented via a transformer-based MLM or via a long short-term memory-based (LSTM-based) MLM.

As to training the ASR MLM with respect to the capability (e.g., as to training the referenced transformer-based or LSTM based MLM), the following is noted. For the circumstance where audio data is received as input, training data can include as training data inputs audio data, and as training data outputs transcript of the audio data with frequency tokens placed in front of the spelled words such that the probability of a frequency token occurring before a word is proportional to the frequency of the word in the training dataset. In this way, frequency information of the words in the training dataset can be injected into the audio transcription learning process of the ASR MLM.

More specifically, placement of frequency tokens in the training data outputs can, as just one example, be according to the probability:

$$p ( < / f > \vert word ) = min ( f ( word ) / {f}_{0} , 1 ) ,$$

where f₀ is a selected frequency cutoff, </f> is the frequency token, and f(word) is the frequency of the given word in the training dataset. It is noted that the frequency token can take many forms. In keeping with this, the frequency token, as discussed herein throughout, is variously depicted as “</f>,” “@,” and “$.”

According to the above equation, words which are frequently present in the training dataset are more likely to be preceded by (or otherwise associated with) the frequency token. The opposite holds for words which are infrequent in the training dataset. Hence, during inference time, if the ASR MLM emits the frequency token before some word W, then it can be inferred that the word W, according to the ASR MLM, is present frequently in the training dataset. To facilitate discussion, the frequency token is in general, discussed herein throughout as being associated with words that are frequent in an at-hand training dataset. However, other possibilities exist. For instance, in various embodiments the frequency token can instead be associated with words that are not frequent in an at-hand training dataset.

As just an illustration, experiments performed on a wide range of datasets of various languages and domains indicate that the discussed usage of a prefix frequency token can help an ASR MLM distinguish between frequently and non-frequently occurring words with an accuracy on order of at least 80-90%.

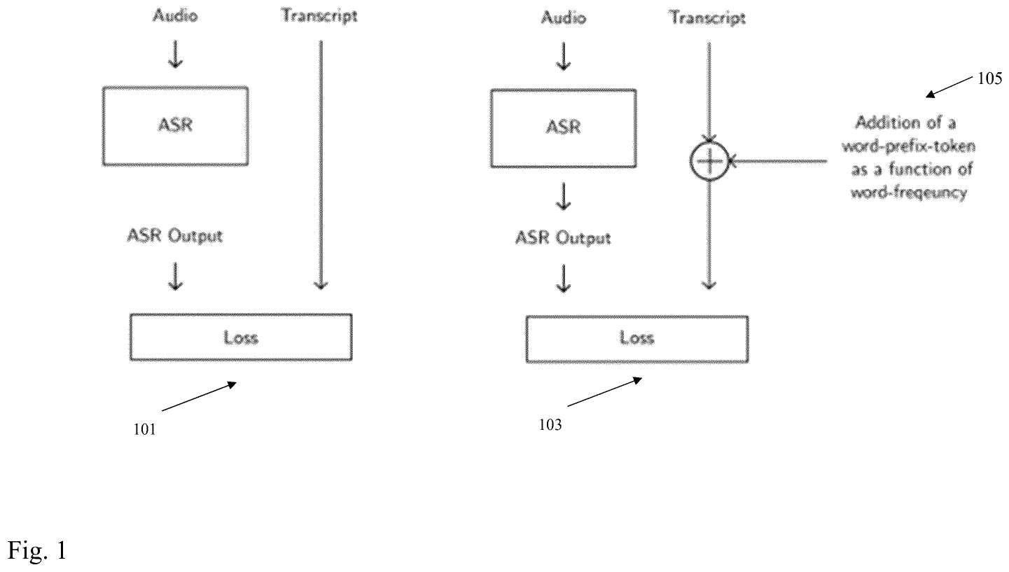

Turning to FIG. 1, shown is an example difference between conventional ASR and the frequency-aware ASR discussed herein. During the training of conventional ASR 101, training data can include as training data inputs audio data, and as training data outputs transcript of the audio data (labeled as “transcript” in the figure). During the training of the frequency-aware ASR discussed herein 103, training data can include as training data inputs audio data, and as training data outputs spellings of words spoken in the audio data (labeled as “transcript” in the figure) and also frequency tokens placed in front of the spelled words 105 as discussed.

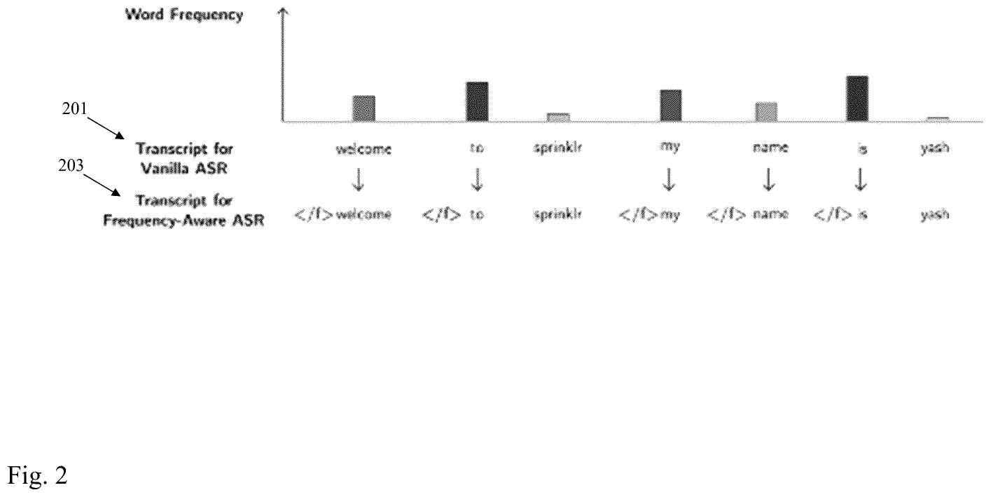

Turning to FIG. 2, shown is an example of how training data 201 used in the training of conventional ASR can be transformed into training data 203 used for the frequency-aware ASR discussed herein. As depicted by the figure, a prefix frequency token can be added in front of words which are frequent in the training data (e.g., “to,” “is,” and “my”), but not in front of words which are infrequent in the training data (e.g., words like “sprinklr” and “yash”).

As referenced, the ASR MLM can be capable of making use of context to help it transcribe the spoken word (e.g., via the use of a contextual finite state transducer (FST)). As also referenced, the ASR MLM can limit its use of this capability to circumstances where the MLM is uncertain of the spelling of the spoken word, such as where the MLM detects that it has not frequently encountered the word in the training word vocabulary, according to the frequency token generation functionality discussed hereinabove.

In particular, where the frequency token generation functionality discussed hereinabove does not emit the frequency token (e.g., </f>) before a certain word, the system can consider it to be the case that the ASR MLM has not seen the word frequently in the training dataset, and hence that there is a higher chance that the ASR MLM would not be able to spell the word accurately. Hence, the system can determine that the ASR MLM should use contextual information when generating a spelling for the word (e.g., during a decoding process of ASR output).

As such, according to a first case if a transcribed word is preceded by (or otherwise associated with) a frequency token (e.g., </f>), then the system can turn off the use of contextual information (e.g., the use of a contextual FST). The use of contextual information can therefore be avoided for words where there is confidence that the ASR MLM is able to spell the word accurately. Then, according to a second case if a transcribed word is not preceded by (or otherwise associated with) a frequency token, then the system can turn on the use of contextual information (e.g., the use of a contextual FST). As such, contextual information can be leveraged for words where there is evidence that the ASR MLM might not be able to spell the word accurately. Since the decision of whether to use contextual information (e.g., whether to use a contextual FST) can be dependent on whether the discussed frequency token generation has emitted a frequency token, such decision functionality can be referred to as token-dependent contextualization.

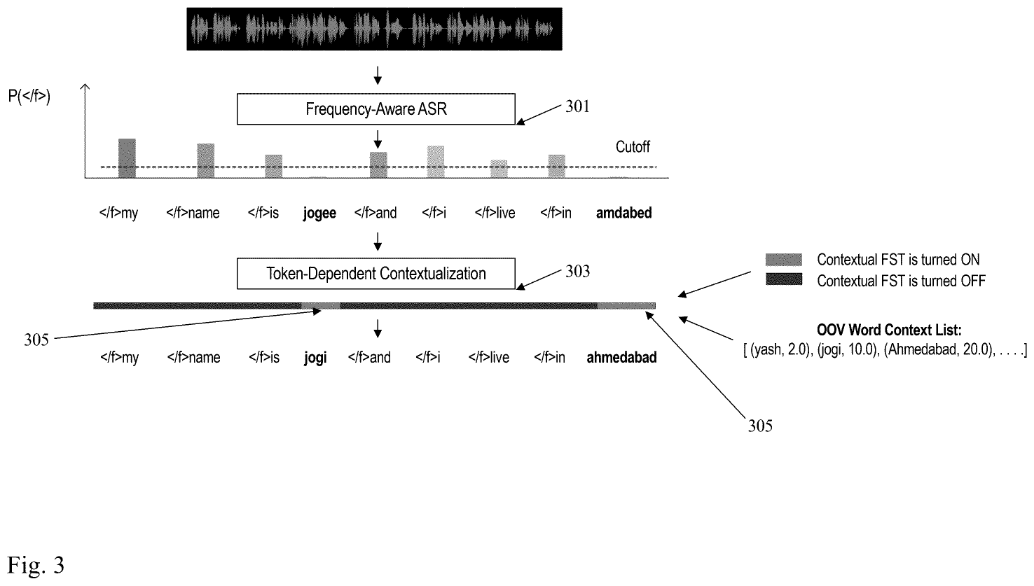

Turning to FIG. 3, shown is an example where the discussed frequency token generation functionality 301 (labeled “frequency-aware ASR” in the figure) places frequency tokens in front of the words “my,” “name,” “is,” “and,” “i,” “live,” and “in.” But, the frequency token generation functionality 301 does not place frequency tokens in front of the words “jogee” and “amdabed.” Therefore, according to the discussed frequency token-dependent contextualization functionality 303, the system can consider it to be the case that the ASR MLM has not seen the words “jogee” and “amdabed” frequently in the training dataset, and that therefore there is an increased chance the ASR MLM would not be able to spell these words accurately. Hence, the system can determine that the ASR MLM should use contextual information when generating transcription for these two words (305).

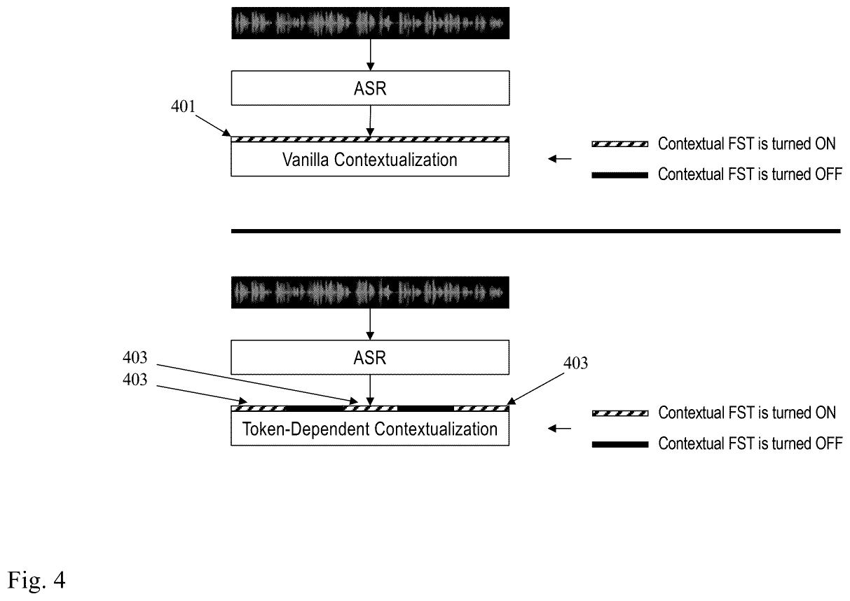

As depicted by the example of FIG. 4, according to conventional approaches contextual information is used (401) during the entire decoding process for the entire audio utterance. In contrast, according to the functionality discussed herein contextual information is used (403) only when the discussed frequency token generation functionality indicates that a certain word was rarely present in the training dataset. As just an illustration, experiments indicate that use of the noted frequency token generation functionality along with use of the noted frequency token-dependent contextualization can reduce over-biasing, one of the main flaws of conventional approaches.

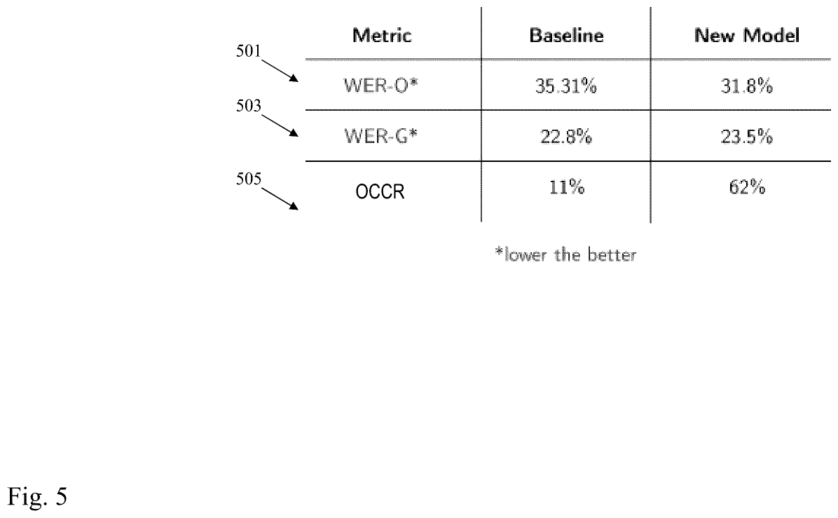

Turning to FIG. 5, shown are example metrics comparing the use of conventional approaches (labeled “baseline” in the figure) to the use of the noted frequency token generation functionality along with the use of the noted frequency token-dependent contextualization (labeled “new model” in the figure). As depicted by the figure, the approaches discussed herein yield better results than conventional approaches for metrics including word error rate (WER) type O 501, WER type G 503, and overall correct classification rate (OCCR) 505.

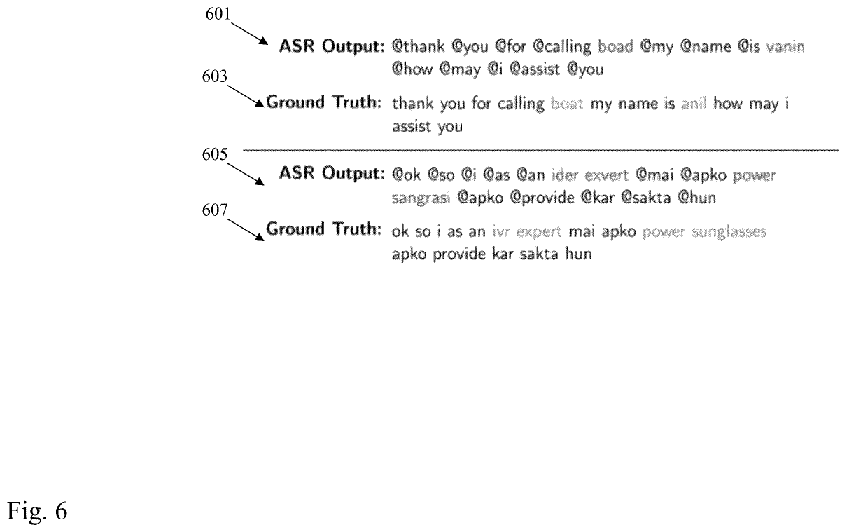

Turning to FIG. 6, depicted are examples of operation of the frequency token generation functionality discussed herein. Shown via example 601 is the frequency token generation functionality having placed a frequency token (“@” according to the example of the figure) in front of all words except for “boad” and “vanin.” Also shown in FIG. 6 is the corresponding ground truth 603. Further according to FIG. 6, shown via example 605 is the frequency token generation functionality having placed a frequency token in front of all words except for “ider,” “exvert,” “power,” and “sangrasi.” Additionally shown in FIG. 6 is the corresponding ground truth 607. It is noted that the second example of FIG. 6 includes latinized Hindi, such that the ground truth 607 in English would read “ok i am an ivr expert i can provide you with power sunglasses.”

According to the equations that follow, it can be deduced that a frequency token can be associated with a confidence measure which can be used to indicate how well the ASR MLM knows a given word that it is transcribing:

$$P ( < / f > ) ∝ f ( w ) \\ E ( w ) ∝ \frac{1}{f ( w )}$$

In these equations, P(</f>) corresponds to the probability of a frequency token </f> being placed before a word w, f(w) corresponds to the frequency of the word w in the training data set, and E(w) corresponds to the error rate of the word w. As such the first equation indicates that the probability of a frequency token </f> being placed before a word w is proportional to the frequency of the word w in the training data set. Further as such, the second equation indicates that the error rate of a word w is proportional to the inverse of the frequency of the word w in the training data set. With regard to the second equation it is noted that while error rate can depend on many factors, one of these factors can be the frequency of the word in the training dataset.

According to various embodiments, during beam search decoding of the ASR MLM output, for a particular time frame t, the set of characters can be set and/or pruned according to the following equations:

$$C ( t ) = \{ < / f > \} if L ( < / f > , t ) \geq {F}_{0} \\ C ( t ) = \{ c ∈ V \vert L ( c , t ) > {P}_{0} \} if L ( < / f > , t ) < {F}_{0}$$

Here, V can be the character vocabulary of the ASR MLM, and L(c, t) can denote the probability of character c at time frame t. Further, F₀ can be the threshold probability for the frequency token, and P₀ be the common character cutoff probability.

As such, according to these equations where the probability of the frequency token (e.g., </f>) at time frame t is greater than or equal to the threshold probability for the frequency token, the character at time frame t can be set to the frequency token. Further as such according to these equations, where the probability of the frequency token at time frame t is less than the threshold probability for the frequency token, the character at time frame t can be set to an at-hand character c (of the vocabulary V) so long as the probability of that character c at time frame t is greater than the common character cutoff probability for character c, with the character c otherwise being pruned.

The use of these equations can provide benefits including allowing the frequency token (e.g., </f>) to be appended to past beams (e.g., to all past beams), at particular time t. Such appending to past beams can allow, for example, for competition between word parts with and without the frequency token to be avoided. Moreover, the use of the noted equations can yield benefits including ensuring (e.g., with certitude or near certitude) that contextual information is used only for a minority of the total words, hence, as just one example, allowing for reduction of over-biasing.

Then, as another example approach for placing frequency tokens in the training data outputs of the ASR MLM, placement can be according to the equations:

$$p ( w ) = 0 if w ∈ V \\ p ( w ) = 1 if w ∉ V$$

Here, p(w) can be the probability that the frequency token is placed before a given word w within the training data outputs. The set V can be, as just some examples, a set of proper nouns or a set of stop words.

According to the above equations, words that are in the set V (e.g., proper nouns) do not receive a placed frequency token within the training data outputs. Likewise according to the above equations, words that are not in the set V (e.g., other than proper nouns) can receive a placed frequency token within the training data outputs. Hence, during inference time, the ASR MLM can place the frequency token before those words that are not in the set V. It is noted that, according to various embodiments, other approaches can be used to place frequency tokens in the training data outputs of the ASR MLM.

The functionality discussed herein can, as just an example, be implemented in connection with a transformer encoder-only ASR (e.g., wav2vec2), along with a connectionist temporal classification (CTC) decoder. As just another example, the functionality discussed herein can be implemented in connection with a transformer encoder-decoder ASR (e.g., Whisper).

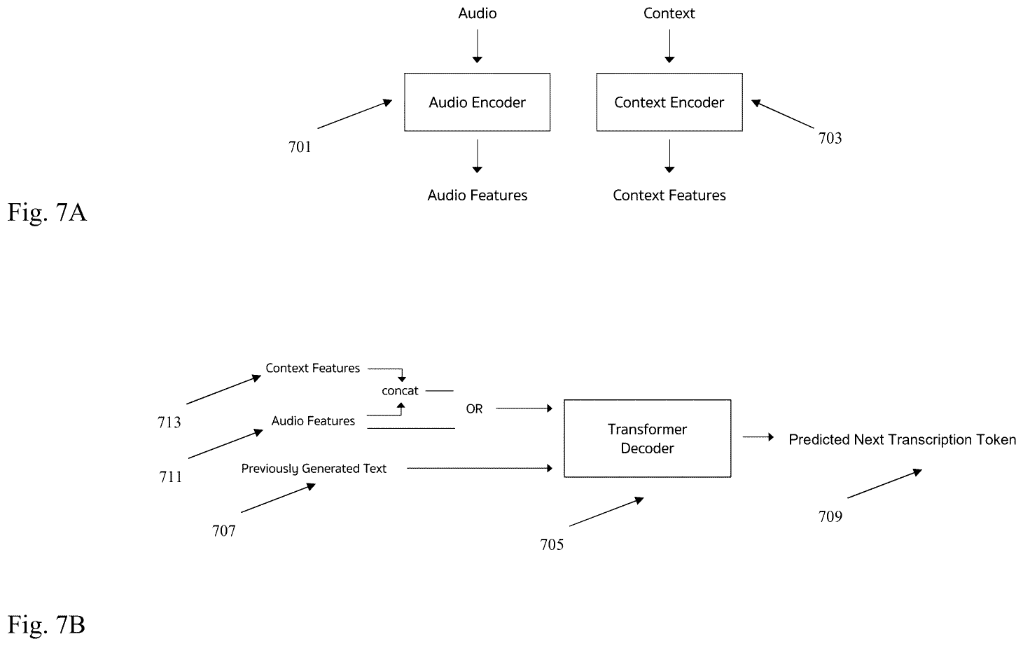

Also, the functionality discussed herein can, as just a further example, be implemented in connection with a transformer encoder-decoder ASR as will now be discussed in connection with FIGS. 7A and 7B. The transformer encoder-decoder ASR of FIGS. 7A and 7B can receive as input, via transformer encoder portion 701, audio data (e.g., audio data corresponding to a telephone conversation between a customer and a service agent). The transformer encoder-decoder ASR can receive as further input, via transformer encoder portion 703, contextual information. The contextual information can be in prose form (e.g., the text “The audio is a customer service conversation regarding a leaky washing machine.”) or in another textual form. The transformer encoder-decoder ASR can generate as output, via its decoder 705, in a tokenwise fashion, a text transcription 709 (labeled “Predicted Next Transcription Token” in the figure) of the audio data. Such text generation by transformer decoder portion 705 can take into account: a) text 707 previously generated by decoder portion 705; b) audio features generated by encoder portion 701; and c) in certain instances context features generated by encoder portion 703.

More specifically, the decoder portion 705 can take into account both (e.g., via concatenation) the audio features generated by encoder portion 701 and the context features generated by encoder portion 703, where an at-hand previously generated transcription token (e.g., word) is not preceded by (or otherwise associated with) a frequency token. On the other hand, where an at-hand previously generated transcription token is preceded by (or otherwise associated with) a frequency token, the decoder portion 705 can take into account the audio features generated by encoder portion 701, but not the context features generated by encoder portion 703. It is noted that, in various embodiments, a predicted next transcription token can serve to replace and/or supersede one or more previously predicted transcription tokens.

The contextual information provided to the encoder portion 703 can, as just an example, be a string. More generally, the contextual information provided to the encoder portion 703 can be any instruction provided to prompt the ASR towards a certain domain or words. As one example, the contextual information provided to the encoder portion 703 can be the text “This audio is a lecture on thermodynamics.” As another example, the contextual information provided to the encoder portion 703 can be text as follows:
“The previous conversation between the speaker and another person is:
Person: Welcome to our company, how can I help you today?
Speaker: Hello, my washing machine is not working.
Person: Sure Sir, please provide your date of birth.”

According to an example use case, the functionality discussed herein can be used to implement an end-to-end confidence measure. In particular, the probability of the prefix frequency token being placed before a given word by the ASR MLM once trained can act as an end-to-end word-confidence measure for that word, the confidence measure indicating how well the ASR MLM has been trained on that word. For conventional ASR, the evaluation metric is typically only a single WER value However, for the functionality discussed herein two WER values can be reported: a) a WER for those words prefixed by the frequency token; and b) a WER for those words not prefixed by the frequency-token. Performed experiments have shown that the WER for words prefixed by the frequency token is typically much lower than the WER for words not prefixed by the frequency token.

According to a further example use case, the functionality discussed herein can be used to estimate the ratio of words which are rare or absent in the training vocabulary, for a dataset D. Such can be a useful metric to determine the quality of the ASR MLM outputs. According to various embodiments, a predicted out of domain (OOD) error ratio PER_{OOD} can be ascertained. Here, OOD can refer to OOV words of the ASR MLM. PER_{OOD} can be determined according to the equation:

$${PER}_{O O D} ( t ) = \frac{N - {N}_{token}}{N}$$

In the equation, t can be a given time, N can be the total number of words in the vocabulary, and Nₜₒₖₑₙ can be the number of words which start with the frequency token (e.g., $).

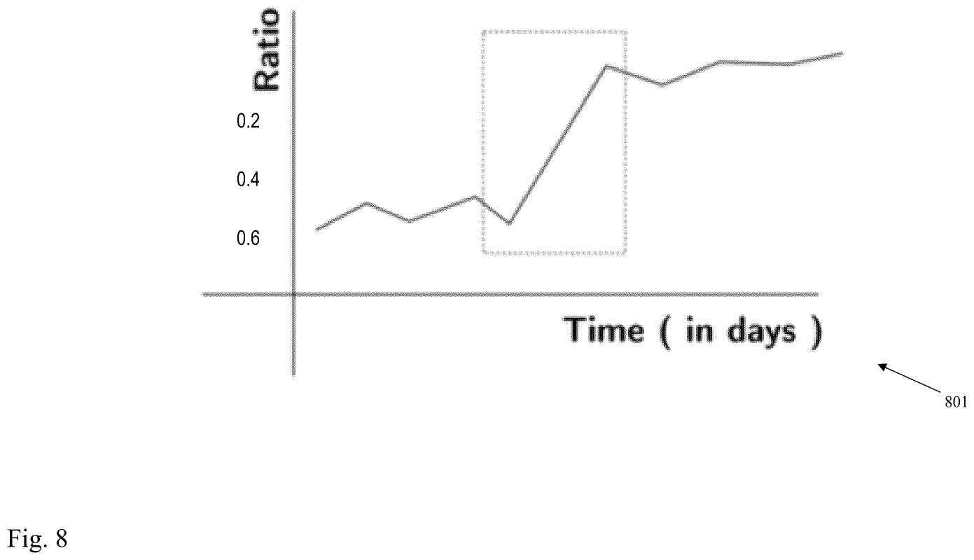

As such, PER_{OOD} can decrease where a greater quantity of words is preceded by (or otherwise associated with) the frequency token. Shown in FIG. 8 is an example plot 801 of PER_{OOD} (labeled “ratio” in the figure) wherein PER_{OOD} decreases as time proceeds, indicative of a greater quantity of words being prefixed by the frequency token, according to the action of the ASR MLM. Use of the noted PER_{OOD} metric can yield benefits including providing insight into how many words are OOD with respect to the ASR MLM, which can be helpful in monitoring a deployed ASR.

As such, according to the functionality discussed herein audio data (e.g., encoding a spoken utterance) can be received by an ASR MLM. Further, in various embodiments a biasing term list including one or more word-terms which have not been used in training the ASR MLM can be received, such as via the discussed contextual information. Also according to the functionality discussed herein, the ASR MLM can be trained in a way where the frequency information of individual words can be injected using a frequency token prefix. As an example, the ASR MLM can be trained to place frequency tokens in front of words such that the probability of a frequency token occurring before a given word can be proportional to the frequency of the word in the at-hand training dataset. As another example, the ASR MLM can be trained to place frequency tokens in front of words such that the probability of a frequency token occurring before a given word can be a selected probability dependent upon whether or not the given word is a member of a certain set of words (e.g., a set of proper nouns or a set of stop words).

Further as such according to the functionality discussed herein, for a given word a probability P( ) can be calculated as the probability that the given word is prefixed by the frequency token. Also according to the functionality discussed herein, such probabilities can be used to generate speech recognition scores. For instance, the probability of the prefix frequency token being placed before a given word can act as an end-to-end word-confidence measure for that word. Still further according to the functionality discussed herein, word pieces (e.g., characters) can be rescored. For instance, for a given time frame, a set of characters can be set and/or pruned according to the equations discussed hereinabove. The set of characters can relate to a decoding graph (e.g., a contextual FST decoding graph) used in generating a transcription for received audio data (e.g., a received utterance).

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

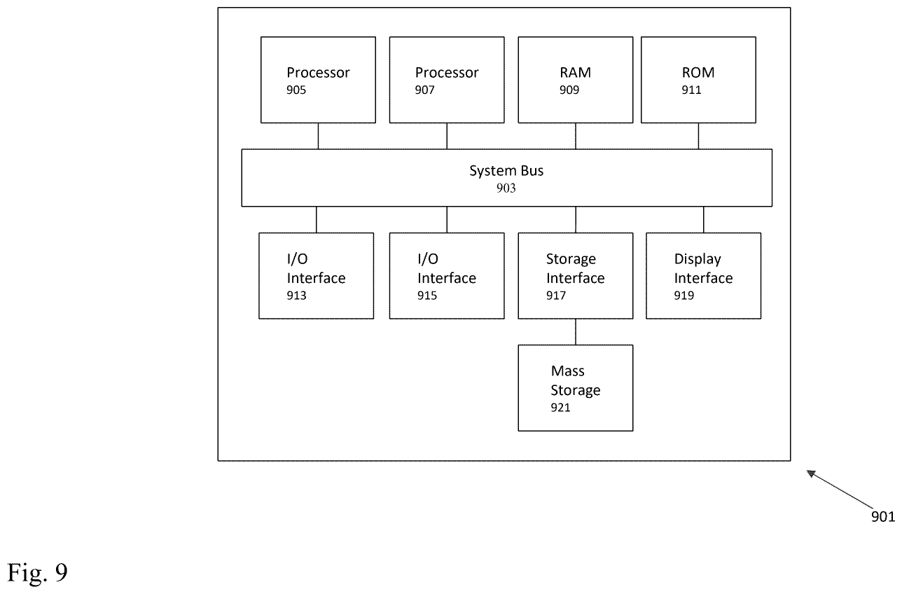

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 9 is an example computer employable in various embodiments of the present invention. Example computer 901 includes system bus 903 which operatively connects two processors 905 and 907, random access memory (RAM) 909, read-only memory (ROM) 911, input output (I/O) interfaces 913 and 915, storage interface 917, and display interface 919. Storage interface 917 in turn connects to mass storage 921. Each of I/O interfaces 913 and 915 can, as just some examples, be a Universal Serial Bus (USB), a Thunderbolt, an Ethernet, a Bluetooth, a Long Term Evolution (LTE), a 5G, an IEEE 488, and/or other interface. Mass storage 921 can be a flash drive, a hard drive, an optical drive, or a memory chip, as just some possibilities. Processors 905 and 907 can each be, as just some examples, a commonly known processor such as an ARM-based or x86-based processor. Computer 901 can, in various embodiments, include or be connected to a touch screen, a mouse, and/or a keyboard. Computer 901 can additionally include or be attached to card readers, DVD drives, floppy disk drives, hard drives, memory cards, ROM, and/or the like whereby media containing program code (e.g., for performing various operations and/or the like described herein) can be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed. It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### RAMIFICATIONS AND SCOPE

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A computer-implemented method, comprising:
generating, by a computing system from audio data, one or more transcribed words,
wherein the computing system, using a machine learning model, selectively associates one or more frequency tokens with one or more of the transcribed words; and
selectively processing, by the computing system based on said association, one or more of the transcribed words using contextual information.

2. The computer-implemented method of claim 1, wherein said selective association corresponds to one or more predictions by the machine learning model that one or more of the transcribed words are in a training data set.

3. The computer-implemented method of claim 1, wherein said selective association corresponds to one or more predictions by the machine learning model that one or more of the transcribed words are in a set of proper nouns, or in a set of stop words.

4. The computer-implemented method of claim 1, wherein the machine learning model is transformer-based or long short-term memory-based.

5. The computer-implemented method of claim 1, wherein the frequency tokens are implemented as one or more characters.

6. The computer-implemented method of claim 1, wherein said selective processing using the contextual information comprises use of a contextual finite state transducer.

7. The computer-implemented method of claim 1, wherein said selective association comprises associating one or more of the frequency tokens with one or more past beams.

8. The computer-implemented method of claim 1, wherein the contextual information comprises prose form information.

9. The computer-implemented method of claim 1, further comprising:
generating, by the computing system using the machine learning model, one or more predicted next transcription tokens that replace and/or supersede one or more previously predicted transcription tokens.

10. The computer-implemented method of claim 1, further comprising one or more of:
determining, by the computing system, one or more confidence measures,
determining, by the computing system, one or more predicted out of domain error ratios, or
determining, by the computing system, one or more speech recognition scores.

11. A system, comprising:
at least one processor; and
a memory storing instructions that, when executed by the at least one processor, cause the system to perform:
generating, from audio data, one or more transcribed words,
wherein, using a machine learning model, one or more frequency tokens are selectively associated with one or more of the transcribed words; and
selectively processing, based on said association, one or more of the transcribed words using contextual information.

12. The system of claim 11, wherein said selective association corresponds to one or more predictions by the machine learning model that one or more of the transcribed words are in a training data set.

13. The system of claim 11, wherein said selective association corresponds to one or more predictions by the machine learning model that one or more of the transcribed words are in a set of proper nouns, or in a set of stop words.

14. The system of claim 11, wherein said selective association comprises associating one or more of the frequency tokens with one or more past beams.

15. The system of claim 11, wherein the instructions, when executed by the at least one processor, further cause the system to perform:
generating, using the machine learning model, one or more predicted next transcription tokens that replace and/or supersede one or more previously predicted transcription tokens.

16. A non-transitory computer-readable storage medium including instructions that, when executed by at least one processor of a computing system, cause the computing system to perform a method, comprising:
generating, from audio data, one or more transcribed words,
wherein, using a machine learning model, one or more frequency tokens are selectively associated with one or more of the transcribed words; and
selectively processing, based on said association, one or more of the transcribed words using contextual information.

17. The non-transitory computer-readable storage medium of claim 16, wherein said selective association corresponds to one or more predictions by the machine learning model that one or more of the transcribed words are in a training data set.

18. The non-transitory computer-readable storage medium of claim 16, wherein said selective association corresponds to one or more predictions by the machine learning model that one or more of the transcribed words are in a set of proper nouns, or in a set of stop words.

19. The non-transitory computer-readable storage medium of claim 16, wherein said selective association comprises associating one or more of the frequency tokens with one or more past beams.

20. The non-transitory computer-readable storage medium of claim 16, wherein the instructions, when further executed by the at least one processor of the computing system, further cause the computing system to perform:
generating, using the machine learning model, one or more predicted next transcription tokens that replace and/or supersede one or more previously predicted transcription tokens.
